(19) United States
(12) Patent Application Publication
(10) Pub. No.: US 2007/0281703 A1
(43) Pub. Date: Dec. 6, 2007

(54) Location-Based Telecommunications Redundancy Protocol

(76) Inventor: Roy Shkedi, Forest Hills, NY (US)

Correspondence Address: JOHN ALEXANDER GALBREATH, 2516 CHESTNUT WOODS CT, REISTERSTOWN, MD, 21136, US

(21) Appl. No.: 10/597,629

(22) PCT Filed: Feb. 22, 2005
(86) PCT No.: PCT/IL05/00216

§ 371 Date: Aug. 2, 2006

(30) Foreign Application Priority Data
Feb. 22, 2004 (IL) 160504

(51) Int. Cl. H04Q 7/38; H04M 3/42

(52) U.S. Cl. 455/445; 455/456.2

(57) ABSTRACT

A protocol for location-based telecommunications redundancy, operable at a data-communications topology juncture having at least two telecommunications media thereat, and the protocol includes the steps of: (1) On the occurrence of a call-processing request from a caller to a recipient—e.g. using a last known present location of the recipient's mobile phone; and (2) Using the current location, second software at-the-juncture propagating the request to “ring” at two call-receiving devices closest to the current location—wherein one of the devices is a mobile telecommunications device of the recipient and the other of the devices is a terrestrial device of the recipient that is closest to the current location of the recipient.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to cellular mobile telephone service, plain old telephone services (POTS), voice over Internet protocol (VOIP) telephony, and to similar voice & data convergent infrastructure transmission media. More specifically, the present invention relates a user application—applicable to elective media & channel opportunities in convergent telecommunications infrastructures.

### BACKGROUND OF THE INVENTION

Today there are two predominant classes of electronic telecommunications interpersonal communications media, those depending on physical interconnectivity infrastructure at the point of service connections (e.g. POTS telephone, VOIP over cable, etc.) and those depending on wireless connectivity (e.g. cellular telephones, pagers, etc.). Now each of these two classes of service has respective advantages over the other. Specifically, physically interconnected services are generally lower in cost, produce less user proximate radiation and produce less overall environmental radiation than wireless services. On the other hand, wireless services are especially convenient—since the user generally has to reach no further than his belt or pocket to benefit from telecommunications interconnectivity as well as ‘personal’ services—since the caller knows the cell phone is carried by its owner the call will be answered either by the recipient or by its private personal voice mail.

In an ideal world, one would like to combine the benefits of each class of service to thereby produce a low cost, healthy, personal and convenient class of hybrid service. Accordingly, we can state that there is a longstanding need in the art for progress in the direction of this hybridization—and that inventive progress in this direction should be well received by the public; since they are generally familiar with the relative benefits of each. According to a lesser measure of real progress, the user should be able to choose between receiving a call over his proximate POTS unit or via his facile wireless unit.

Turning to the factor of relative costs, one can assert that, specifically, so long as there exist a monetary disparity between substantially like quality-of-service telecommunications “products”, there will be a need for facilitating preferential use of the less expensive product.

For example, John wants to place a call to Jane. Jane has both a POTS terrestrial infrastructure telephone and a mobile cellular infrastructure telephone. If Jane (the intended call recipient) can presently be reached on either her POTS or mobile units, and if it cost Jane less to receive the call at the POTS unit than to receive the call at the mobile unit, then Jane (the recipient) would probably prefer to receive the call at her POTS unit. Likewise, if in some telecommunications franchise intersection, the rate structure for a POTS call is more expensive than that for a mobile call, then Jane (the recipient) would probably prefer to receive the call at her mobile unit.

This simple “choose cheapest among equals” heuristic is equivalently true (for all recipients) in the present American telecommunications climate—where the mobile recipient pays for the link from the terrestrial infrastructure through the cellular infrastructure and to the mobile unit. However, this same logic is reversed in the present European telecommunications climate where the caller to the mobile recipient pays for the final linkages, and for any other regulatory combination. Simply stated, the heuristic preference for cheapest among equals is the normal logical micro-economic choice for the vast majority of telecommunications service subscribers.

Returning to the variables of cost, health, personal and convenience service, a factor that many people consider as relevant to accepting or rejecting the simple micro-economic heuristic preference is health, since the economic equivalent to health depends on complex cultural and personal assumptions (beyond the scope of the present remarks). Simply stated, there are people who believe that the cellular telephone mobile units, in specific, may contribute to damages to the health of the user—perhaps due to exposure to microwave radiation or perhaps due to other less clearly articulated factors. Likewise there are other people who believe that serious EMF radiation along the right-of-way of terrestrial lines (generally over-ground unshielded telephone cable) cause environmental perturbations to plants, wildlife and persons living close to these lines; complete with their negative macroeconomic impact.

Finally, the factors of convenience and personal service must be. considered, since an important factor is to reach the recipient wherever he is, which is one of the cell phone's biggest advantages. When you place a call to a terrestrial line connected telephone, you never know whether the recipient is there; while if you place a call to a cell phone, you know for sure that he is. From the recipient perspective the cell phone provide him with a personal line. Whoever calls the cell number is calling him personally.

When trying to provide a solution that establishes a connection between the caller and the recipient, we need to make sure that, in addition to establishing the lowest price & ‘healthiest’ connection, we also conveniently and personally reach the recipient; and not someone else.

In any event, while the caller or the receiver may have preferences in choosing one telephony media over another, the primary goal of the caller is to reach the desired destination and make contact with the intended receiver. In order for the call to be completed, the receiver must be at the terrestrial unit or she must be at the active mobile unit. According to the lifestyles of today's often-dual service (terrestrial and mobile) users, there becomes an increasing probability of reaching an electronic mail box instead of the intended receiver. In addition to the aforesaid economic heuristic and the health & environmental concerns, there remain a growing need for the receiver and/or the caller to preferentially elect one of two (or more services) in circumstances where a plurality of instant services are available.

Various service packages have been developed to help the receiver receive calls at destinations preferred by him. These packages typically include some call forwarding link—so that a different terrestrial or mobile unit will ring (signal) in place of the original destination. In the call forwarding service, it is the recipient who pays the cost of the forwarding link. So call forwarding helps reach the destination, but it is not effective; because in Europe the caller still pays for calling a mobile number and in the US the recipient may save incoming air minutes—however, when his home phone rings (for example) the recipient does not know if the call is for him or his wife or children. The recipient child may pickup an important business call that was forwarded from his parent's cell phone to their home phone, etc. Thus, we return to our initial observation, that the cellular telephone affords it owner a much higher level of convenience and personal service than do POTS systems or the likes.

Nevertheless, others have been long aware of the disparity of benefits between mobile and POTS systems; so that other service improvements have been developed, such as those that may be learned from:

(1) U.S. Pat. No. 6,446,127—System And Method For Providing User Mobility Services On A Telephony Network

(2) U.S. Pat. No. 6,584,490—System And Method For Providing Call-Handling Services On A Data Network Telephone System

(5) Methods And Systems For Call Routing And Codec Negotiation In Hybrid Voice-Data-Internet-Wireless Systems—WO 00-51330

(6) System And Method For Call Routing In An Integrated Telecommunications Network Having A Packet-Switched Network Portion And A Circuit-Switched Network Portion—WO 01-22766

(7) Telecommunications Network Integrating Cellular Packet-Switched And Voice-Over-IP Infrastructures—WO 1-76276

In today's totally computerized telecommunications infrastructures, virtually any logical combination of services is feasible, so long as the combination respects hard physical restraints such as bandwidth availability, environmental signal to noise reality, computational complexity limits, and the likes. Nevertheless, with the ongoing convergence of routing, switching and packet networks, the convergence of computational, signal processing and data delivery systems, and the convergence of land-based copper-wire lines, trans-oceanic cable trunks, trans-continental satellite links, and wireless cellular systems—the variety of logical service combinations (which can be technologically actualized) seems to exceed the scope of understanding of the ordinary man of the art. Hence, the present epoch's outpouring of creative efforts to conceptualize and actualize new service combinations having appreciable advantages over existing modes of telecommunications operations.

However, in light of all of these factors and in light of the ongoing explosion of literature in the telecommunications arts, there remains a need in the art for a method that will allow a recipient to achieve some actualization of his inherent desire for implementing a cost reduction heuristic either for himself in the US or for the party calling him in Europe; according to straightforward cost considerations, or according to longer range health or environmental considerations; and nevertheless maintain the advantages of a cell phone, which means that when it rings the call is for you. Simply stated, there is a longstanding need to allow the recipient to reduce his/her telecommunications expenses in the US or the caller's expenses in Europe without concurrently reducing his/her convenience and personal qualities of the service.

### ADVANTAGES, OBJECTS AND BENEFITS OF THE INVENTION

Technical Issues: The instant invention is capable of implementation using off-the-shelf infrastructure, software, and known real-time knowledge engineering techniques. According to a preferred embodiment implementation, a special simple-circuit device is installed at one or more POTs telephone to wall-jack connections; in order to reduce implementation complexity—even for the off-the-shelf infrastructure.

Ergonomic Issues: Without loosing any of the general convenience of the cellular telephone, the instant invention allows callers (e.g. in the European regulatory climate) and/or call recipients (e.g. in the American regulatory climate) to exercise choice over the preferred economic, health and/or environmental aspects of their participation in propagating a call over service redundant telecommunications infrastructures.

Economic Issues: According to embodiments of the present invention, when a caller and/or a recipient exercises his/her right-of-preference, the result is an instant, short-range or long-term economic saving to the individual and/or his/her society.

### BRIEF SUMMARY OF THE INVENTION

The aforesaid longstanding needs are significantly addressed by embodiments of the present invention, which generally relates to a protocol for location-based telecommunications redundancy. The instant protocol is especially useful in man-computer-telecommunications interactions wherein there exists a preference on the part of a recipient and/or on the part of a caller to the call of that caller as to which device and/or media the call is to be receive on—mobile or terrestrial. NOTE: for simplicity of understanding, we will continue the description—specifically allowing the recipient to choose the ultimate medium for receiving a call—albeit alternate caller electing embodiments of the instant invention are technologically equivalent according to functional analysis and respective econometric considerations.

In the context of the present invention, a mobile telephone is a wireless device that is accessible by a base station which itself accesses a number of devices. In this context, the mobile phone is preferably a cellular micro-wave-type telephone; however the mobile phone might be a direct-with-satellite linked telephone, a pager, or even a personal wireless position reporting GPS enabled device that is likewise capable of receiving a device specific addressable signal. Furthermore, in the context of the present invention, a terrestrial telephone is device that is preferably physically connected to a fixed telecommnunications infrastructure—such as the Historic POTs branch & trunk exchanges or the newer Internet, LAN & WAN networks including VOIP (Voice over Internet Protocol). Nevertheless, in the context of the instant invention, a local private “base station” enabled portable hand-held unit (cordless handset) is substantially synonymous with its respective POTS or Internet base station—and accordingly should be considered as a terrestrial telephone device—even though its last mini-link is not a physical connection.

Now, more specifically (see FIG. 1), the instant invention relates to embodiments of a protocol for location-based telecommunications redundancy (100), operable at a data-communications topology juncture (110) having at least two telecommunications media there-at and the at least two media are for an intended call recipient (and at least one of these at least two media is a mobile phone of a call recipient—as defined above), and the protocol includes the steps of: (A) On the occurrence of a call-processing request from a caller to a recipient, first software at-the-juncture accessing (120) a substantially current location for the recipient based on a mobile telecommunications device location of the recipient's; and (B) Using the current location, second software at-the-juncture propagating (130) the request to “ring” (signal) at two call-receiving devices closest to the current location—wherein one of the devices is the mobile telecommunications device of the recipient and the other of the devices is a terrestrial device of the recipient that is closest to the current location of the recipient.

Clearly, it is preferred that the ringing mobile phone be close enough to the terrestrial device for the recipient and other people using the terrestrial device to appreciate that the incoming call (on both media) is the same call and is intended for the ringing mobile phone owner. Thus when both units essentially begin to ring simultaneously, the recipient may choose to answer either—according to his preference for micro-economic savings, etc. In addition, the terrestrial device is preferably ringing with a different ringing tone in order to signal people using the device not to answer unless their cell phone is simultaneously ringing (such different ringing tone at the terrestrial device is implemented using distinctive ringing—e.g. RingMate, RingMaster, Multi-Ring, Smart Ring, Personalized Ringing). The different ring tone at the terrestrial device is also important in cases the mobile phone owner is recognized by the system as being next to the terrestrial device when actually the cell phone owner is close but not close enough. One such a scenario will be in sparsely populated rural regions, where the mobile phone is not proximate to the terrestrial unit—even though our knowledge of their respective locations places them in the same cell. Likewise, for example, in a dense urban setting, when the cell phone user steps out to his local news-stand, he will already be outside of the cell of his apartment. Furthermore, for the same user, stepping into his neighbor's apartment will not yield a quantifiable difference in location between his cell phone and his home phone—so both will ring simultaneously—even though he is not at home. The different ring tone at the terrestrial device will alert people next to the device not to answer the phone if their cell phones are not simultaneously ringing.

Note: The juncture may exist under the primary control of either media or under the primary control of a third-party service provider—where the ability to simultaneously call several telephone numbers (such simultaneous calling ability can be provided by Nortel's DMS-100 Wireless system or a Session Initiated Protocol (SIP) or equivalent) is a feature of the software service (or hardware service) infrastructure. The at least two telecommunications media must include a mobile telephone media as one of the at least two telecommunications media. It should be also noted that in one possible embodiment of a protocol for location-based telecommunications redundancy, the protocol is implemented over a distributed data-communications topology junctures where one juncture includes a mobile telephone media and the at least one other juncture includes the other media where the mobile phone owner can be reached based on his location. Simply stated, there are numerous possible embodiments of a protocol for location-based telecommunications redundancy; and in particular, the protocol may be implemented over a distributed data-communications topology where multiple physical junctures form a single logical juncture (e.g. where one physical juncture includes a mobile telephone media and the at least one other physical juncture includes the other media where the mobile phone owner can be reached based on his location).

In considering the practicality of embodiments of the instant invention, it must be noted that an enhanced 911 requirement (which mandates that US wireless carriers provide location accuracies of 50 to 100 meters for emergency 911 calls by the end of 2005) is driving incorporation of location-sensing systems into mobile phones using GPS, base-station triangulation methods, and a combination of these technologies known as Assisted GPS. (Similar requirements exist in the European Union.) Essentially, the enhanced 911 facility does not require any not-yet-invented technology.

Once the 911 enhancement is implemented, the cell phone geographical coordinates could be recorded as well as the coordinates of the terrestrial devices that will be received from a registration process where the cellular phone will be placed next to the terrestrial device and the coordinates of it will be recorded as the coordinates of the terrestrial device. Then, when a call will be made to the cell phone, if the cell phone coordinates will be within a radius of 50 meter from the coordinates recorded for the terrestrial device (during the registration process) a subscriber would like to be reached at when there, the call will also be propagated to the terrestrial device. By using the cell phone reported coordinates as the location for the terrestrial devices which it is next to during the registration process, we will avoid possible scenarios where the cell phone reported coordinates are not accurate or the terrestrial device coordinates are not accurate and therefore the subscriber is not recognized as being at a place (where he would like to be reached at on a terrestrial device when there) although he is.

Returning to the examples in the background section, Jane, a mobile phone user provides her mobile phone service provider a list of telephone numbers and optionally a list of instant messages identities at locations she may be at when her mobile phone is being called. When Jane is at one of the locations (that she provided her mobile phone service provider with telephone numbers of when her mobile phone is being called), Jane would like to have the telephone at that location (with the number she provided her cell phone provider with) ring simultaneously with her cell phone. Therefore, giving Jane an alternative to answer her call—not on her cell phone but on the other ringing phone. Answering the call not on her cell phone but on any ILEC (Incumbent Local Exchange Carrier) provided line provides Jane with a better call quality. Answering the call not on her cell phone but on any other fixed phone (such as ILEC provided phone or VOIP based phone that may be provided by a broadband provider or an Instant Messenger provider or just anyone) provides Jane with a healthier call since she will not have to sustain spurious radiation from her cell phone. In the US where the cell phone subscriber pays for the airtime of incoming calls, answering on any device but her cell phone saves Jane precious airtime minutes that could be used by her later for calling people from her cell phone. In Europe where the calling party pays for the airtime minutes of the call, if Jane answers the call on any device but her cell phone reduces the calling party's call cost.

Regardless whether Jane is located in the US or in Europe, when Jane is at a location where she gave her cell phone service provider a number she could also be reached at when at that location and her cell phone provider identifies she is there based on her cell phone location and then when someone calls her cell phone the cell phone service provider simultaneously ring both her cell phone and the telephone number at that location Jane KNOWS the call on the ringing device that its number she gave her cell phone service provider is intended for her since her cell phone is ringing simultaneously. Optionally, the device with the telephone number Jane gave her service provider at that location, when called by Jane's cell phone service provider, rings with a different ring tone to alert other people using the device not to answer the call on the ringing device unless their cell phone is simultaneously ringing. Therefore, Jane and the person calling her benefit from the personal qualities of a cell phone although Jane answers the phone on a line she maybe shares with others—the person is calling Jane on her cellular personal number where he knows only Jane answers and get a hold of Jane and Jane alone but on a shared phone line such as Jane's home line where she shares the line with other family members.

Also, if Jane does not answer a call both on her cell phone as well as on the device she designated her cell phone service provider she would like ringing when she is at a location where she is now, the call will be picked-up by the cell phone voice mail, which is Jane's personal voice mail, in order to once again maintain the personal qualities of a cell phone for both Jane and the person calling her even when Jane has the alternative of answering her calls on devices that are not her personal telephone lines.

In Europe a telephone provider that would like to increase the voice traffic of its subscribers may offer them to reach cell phone users they would like to reach for a lower cost by reaching those users at lower cost alternatives. In other words if Jane is a subscriber to the service described in this invention, John could be encouraged to call her more if he knew that a call would be established by his phone provider only if Jane would pick up the call on a lower cost telephone media than her cell phone. One possible implementation will be that John would dial *45 for example before dialing Jane's cell phone number therefore signaling its phone provider that he would like a call established only if Jane answers the call on a terrestrial line, which is cheaper for John to call. In this scenario Jane's cell phone provider will not transfer the call to Jane if she is not at a location where she can be reached at another device, it will instead transfer John directly to Jane's voice mail. If Jane's cell phone provider recognizes based on Jane's cell phone location that Jane is at a location where she can be reached on a terrestrial line, it will transfer John's call to the terrestrial line while simultaneously ringing Jane's cell phone using a special ring tone that will indicate to Jane that first of all the call on the ringing terrestrial line is intended for her and secondly that she can answer the call only on the terrestrial line since the caller does not want to speak with her on the more expensive cell phone.

According to one detailed variation embodiment of the instant invention, the subscriber to the service described in this invention easily and simply adds telephone numbers and instant messengers identities at locations where he would like to be reached at when there in the following way:
The subscriber picks up the telephone device where he would like to be reached at and calls a telephone number provided by his cell phone provider for the purpose of managing the numbers he would like to be reached at. The subscriber is calling this number while his cell phone is placed next to him.
An automatic system answers the phone and ask the subscriber to enter both his cellular telephone number as well as his pin number for identification purposes.
Once the system identifies the subscriber based on his cell phone number and his pin number (the same pin number used by the cell phone user to access his cellular voice mail or a different access code the user received from his cellular provider), the system which recognizes the number the user is calling from (using caller ID) offers the user to add the number to the list of numbers where he could be reached at.
If the user chooses to add the number to the list, the system checks which cell does the user's cell phone currently resides within and record the cell's ID next to the telephone number the user would like to be reach at when at that location. From now on whenever the cellular provider will recognize that the user is within this specific cell, in addition to calling the person on his cell phone it will also simultaneously call him on the phone number associated with this cell.
If the number the user is calling from is already on the user's list of numbers he would like to be reached at, the system checks which cell does the user's cell phone currently resides within and in case the current cell ID is different than the cell ID currently associated with the number the user is calling from, the system asks the user whether he would like to update the number's location or keep the old location. In a world where VOIP calls can be made from any place with broadband connection to the internet using an adapter that connects any regular analog phone to the Ethernet, turning the traditional phone into an IP device (such an adapter for example is the Cisco ATA 186), this feature is very important since it enables the user to receive calls made to his cell phone on his VOIP phone if he is next to it.
In a world where many instant messengers can be used for voice conversations, a user may add his instant messenger identity to the list of numbers he would like to be reached at when there in the following way:
The user uses his instant messenger to send an instant message to an address/Instant Messenger ID provided by the cellular provider for the purpose of managing the list of instant message identities a user would like to be reached at when there.
The system reply to the user with an automatic instant message reply that ask the subscriber to enter both his cellular telephone number as well as his pin number for identification purposes.
Once the system identifies the subscriber based on his cell phone number and his pin number (the same pin number used by the cell phone user to access his cellular voice mail or a different access code the user received from his cellular provider), the system offers the user to add the instant message identity he just used to contact the system to the list of numbers and instant message identities where he could be reached at if there.
If the user chooses to add the instant message identity to the list, the system checks which cell does the user's cell phone currently resides within and record the cell's ID next to the instant message identity the user would like to be reached at when at that location. From now on whenever the cellular provider will recognize that the user is within this specific cell, in addition to calling the person on his cell phone it will also simultaneously call him on the instant messenger identity associated with this cell.
The location of the instant messenger identity can be easily updated by sending the system an instant message from a new location.
Numbers and instant message identities where the user would like to be reached at when there could also be deleted from the list by calling or instant messaging the system and doing so.

In another embodiment, the subscriber easily and simply adds telephone numbers and instant message identities at locations where he would like to be reached at when there by using his cell phone it self when he is next to the device where he would like to be reached at in the following way:
The subscriber calls or SMS his cellular provider using his cell phone and register the telephone number or the instant message identity at his provider. By using the subscriber's cell phone and not the telephone device or instant messenger (where he would like to be reached at) to register, the cellular provider ‘saves’ the subscriber the authentication steps described above (when using the terrestrial device or the instant messenger to register) therefore shortening and simplifying for the subscriber the management of the telephone numbers and instant messenger identities where he would like to be reached at. Thus, specifically, the instant invention also relates to embodiments of a location registration method, for use in the protocol for location-based telecommunications redundancy, and the method includes the steps of (A) from a substantially mobile phone (preferably a cellular micro-wave-type telephone; however adequately a direct-with-satellite linked telephone, a pager, or even a personal wireless position reporting GPS enabled device that is likewise capable of receiving a device specific addressable signal, or the likes) located next to a connected substantially terrestrial telecommunications unit (e.g. POTs telephone, a fixed-location interconnected computer, VOIP enabled instant messenger or the likes), transmitting (e.g. SMS, calling, etc.) an accepted terrestrial-system identification number (e.g. telephone number, or the likes) for the terrestrial unit; (B) at a predetermined juncture in a data-communications topology, recording the identification number in logical association with the cell phone location. The cell phone location will be in a worst case scenario the base-station antenna-space location where the cell phone resides within and in the best case scenario the highest possible accuracy as generated from a differential GPS

Managing the cell phone user list of numbers and instant message identities where he could be reached at in the above described way is important not only since it is easy and simple for the user but even more important since it enables the cellular provider to associate telephone numbers and instant message identities the user would like to be reached at with the correct cells at the locations the user would like to be reached at. The importance of the above will be clear from the following simple example: a user would like to have his city home phone ring when he is at home. In a dense urban environment where multi-path and fading are some of the characteristics of the cellular communications, the cell phone device when at home may be connected to the network through a cell which its center is more distant than another cell since the more distant cell has a better connection with the cellular device. Therefore, if the cellular provider would have tried to associate the user's home number with the cell that its center is geographically nearest to the user's home address, then the user would not have been recognized as being home when being there by the cellular provider since in reality when at home the user was connected to the cellular network through a more geographically distant cell that has a better connection with the cell phone device.

Nevertheless, according to another variation embodiment, the cellular provider may associate numbers the user would like to be reached at with the cells the user will reside within when staying at the locations where telephone devices with those numbers are there in other ways including the comparing of the addresses of those locations as provided by the user or as taken from a database to the addresses of the cellular provider cells or even better by comparing those locations addresses with cells coverage map or database that according to it the cellular provider knows which cell of its cover which addresses and can associate accordingly numbers with cells.

According to a further variation embodiment, substantially current location for the recipient is derived from obtaining coordinates corresponding to a cell of the recipient's mobile telecommunications device. The purpose of using a coordinate is to make minimal the necessary infrastructure knowledge of each the various telecommunications infrastructure providers with respect to any of the other providers. Hence, one provider need not understand the routing codes, area codes, prefixes, trunk designations, branch exchange designations, base station codes, etc. of another provider. In the context of this variation embodiment, it is preferred that the coordinates are selected from the list: (A) A geographic map reference, (B) A telecommunication infrastructure logical location, (C) A mobile telecommunication service cell, (D) A mobile telecommunications micro-cell, (E) A mobile telecommunications antenna coverage location, or the likes. However, a thirds party service provider may find it adequate to keep a large database of precompiled matching tabled between infrastructure addresses of one provider and those of another. Simply stated, the technical step for co-joining a substantially simultaneous feature even in two different service provided media is accomplished by forming a transformation of the end unit address (physical or logical) for one media onto the end unit address for another media. Thus, it may be completely adequate and equivalent to use known instillation address (post code, street, building number, etc.) as the coordinates of the terrestrial devices and/or the instant message identities, etc.

According to another variation embodiment of the instant invention, the substantially current location for the recipient is derived from obtaining coordinates corresponding to an area of preference designated by the recipient. Such embodiment may prove useful in a scenario where the subscriber wants to receive calls dialed to his work phone on his cell phone as well, only when he is in close proximity to his work place. This way, when the user is at work or next to work, where he is during work hours, he does not miss important calls while if he is at home—he is not bothered with work related calls. In such a scenario the subscriber will provide his work phone number as his location and the system will therefore route calls dialed to his work phone to both his work phone and his cell phone only when the system recognizes that his cell phone is within the same cell as his work phone. Otherwise, the system will route the call dialed to his work only to his work phone.

According to another variation embodiment of the instant invention, the substantially current location for the recipient is derived from obtaining coordinates corresponding to the cell area where the recipient's mobile device is within and not precise coordinates (as provided by a GPS for example)—since the precise location of the recipient is not strictly necessary. The reason that a cell area is good enough as a location for the recipient is that most recipient in today's modern sprawling life style landscapes rarely live and work in the same cellular access area, nor are the dwellings of their most familiar companions, co-workers, relatives, or friends in the same cellular access area either. Simply stated, the viability of the instant protocol is appropriate for the modern lifestyle.

Now, according to the preferred instant embodiment, an application to add a terrestrial unit & its location will take place from the location of the terrestrial unit in the immediate proximate presence of the cellular unit. Typically, the cellular unit will register the terrestrial units phone number—when the user is standing next to the terrestrial unit—or equivalently, the terrestrial unit will register itself at the account of the present cellular protocol service, when the cellular unit is immediately near by.

According to a further variation embodiment of the instant invention, the propagating of the request to “ring” (signal) at two call-receiving devices closest to the current location is selected from the list: (A) Substantially simultaneously to both devices; (B) According to the preference of the recipient, first to the recipient's mobile device and after a predetermined time interval simultaneously to both devices; (C) According to the preference of the recipient, first to the recipient's terrestrial device and after a predetermined time interval simultaneously to both devices: (D) According to the preference of the caller, first to the recipient's mobile device and after a predetermined time interval simultaneously to both devices; and (E) According to the preference of the caller, first to the recipient's terrestrial device and after a predetermined time interval simultaneously to both devices. However, recalling the preferred scenario, it is the mobile phone that can ring first—or at least substantially simultaneously with at proximate predetermined known associated POTs unit. These variations firstly relate to allowing the recipient and/or the caller to be the determining elector of the media according to any of the heuristic options listed in the background section, and secondly relate to ergonomically biasing the preference by placing a predetermined delay between ringing the first device and effecting simultaneous ringing of both devices. Essentially, the predetermined delay is shorter than the interval that triggers intervention by a voice mail systems.

The instant invention also relates to embodiments (see FIG. 2) of an article of manufacture (200) including a computer usable medium having computer readable program code embodied therein for facilitating a protocol for location-based telecommunications redundancy, operable at a data-communications topology juncture having at least two telecommunications media there-at, the computer readable program code in said article of manufacture including: (A) first computer readable program code (210) for causing a computer to, on the occurrence of a call-processing request from a caller to a recipient, accessing a substantially current location for the recipient based on his mobile telecom device location which is either the cell which the device resides within or a coordinate transmitted by the device's GPS or the likes; and (B) tied to the first computer readable software, second computer readable program code (220) for causing the computer, using the current location, propagating the request to “ring” (signal) at the telecom mobile device and at the phone which his number is associated with the cell the telecom mobile device resides within or the instant messenger identity that is associated with the cell the telecom mobile device resides within.

Embodiments of the instant invention also relate to (see FIG. 3) a program storage device (300) readable by machine, tangibly embodying a program of instructions executable by the machine to perform steps for facilitating a protocol for location-based telecommunications redundancy, operable at a data-communications topology juncture having at least two telecommunications media there-at, said steps including: (A) Maintaining (310) a substantially current location for a mobile device of a recipient; (B) Accepting (320) from the recipient a list of numbers and instant message identities where he would like to be reached at. (C) Each number and instant message identity respectively associated with a cell ID or geographical coordinates. Furthermore, the mobile telecom device's geographic location may be determined in advance or in real time—of which adequately constitutes a valid maintenance of the substantially current location.

NOTICES: Numbers, alphabetic characters, and roman symbols are designated in the present and the following sections are for convenience of explanations only, and should by no means be regarded as imposing particular order on any method steps. Likewise, the present invention will forthwith be described with a certain degree of particularity, however those versed in the art will readily appreciate that various modifications and alterations may be carried out without departing from either the spirit or scope, as hereinafter claimed. Furthermore, in describing the present invention, explanations are presented in light of currently accepted technological theories and/or mercantile models. Such theories and models are subject to changes, both adiabatic and radical. Often these changes occur because representations for fundamental component elements are innovated, because new transformations between these elements are conceived, or because new interpretations arise for these elements or for their transformations. Therefore, it is important to note that the present invention relates to specific technological actualization in embodiments. Accordingly, theory or model dependent explanations herein, related to these embodiments, are presented for the purpose of teaching, the current man of the art or the current team of the art, how these embodiments may be substantially realized in practice. Alternative or equivalent explanations for these embodiments may neither deny nor alter their realization.

### BRIEF DESCRIPTION OF THE DRAWINGS

In order to understand the invention and to see how it may be carried out in practice, embodiments including the preferred embodiment will now be described, by way of non-limiting example only, with reference to the accompanying drawings. Furthermore, a more complete understanding of the present invention and the advantages thereof may be acquired by referring to the following description in consideration of the accompanying drawings, in which like reference numbers indicate like features and wherein:

FIG. 1 illustrates a schematic view of an embodiment of a protocol for location-based telecommunications redundancy;

FIG. 2 illustrates a schematic view of an article of manufacture including a computer usable medium having computer readable program code embodied therein for facilitating a protocol for location-based telecommunications redundancy;

FIG. 3 illustrates a schematic view of a program storage device readable by machine, tangibly embodying a program of instructions executable by the machine to perform steps for facilitating a protocol for location-based telecommunications redundancy;

FIG. 4 illustrates a schematic systems design view of an instant invention MobileLine middleware applications—coordinating wireless with landline facilities.

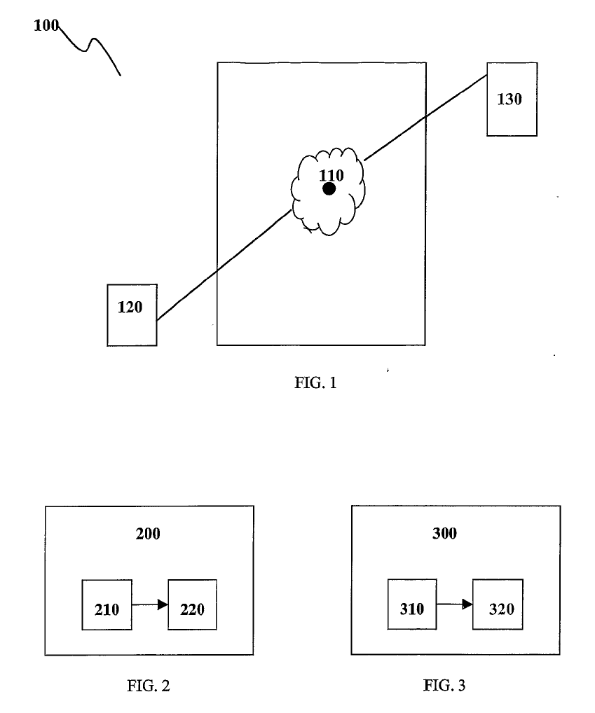

### DETAILED DESCRIPTION OF THE INVENTION

The preferred embodiment of the instant invention is called Mobiline—meaning a line that is mobile—for an infrastructure juncture—at least including a mobile cellular phone and a land phone. Calls to the subscriber generate simultaneous rings (facilitated via a wireless system such as Nortel's DMS-100 Wireless system or via SIP—Session Initiated Protocol) on his cell phone and land line geographically located next to his cell phone where the land line could be a VOIP phone, any ILEC provided line the subscriber wants it to ring and optionally on the subscriber's Instant Messenger.

The subscriber (the intended recipient of a call) may answer the call on any of the ringing devices while obviously answering the call not on his cell phone saves the subscriber precious airtime minutes that can be used for outgoing calls as well as provide him with the quality and convenience of a land line. Note: From a cost perspective—in the US—the receiving party pays for incoming calls air time; while in Europe—the calling party pays for the airtime. The subscriber benefits from his personal cellular voice mail, which picks-up the call if he does not answer at any of his designated devices. Alternatively, the cellular provider may offer the user to have his call picked-up by any other voice mail of his choice. (Recall that, for example, a mobile telecom device could be a cell phone, a pager or any other wireless device that its proximate location can be determined)

In one embodiment, the Mobiline provider will be a cellular provider that will use the ‘group calling’ feature of its wireless system to conduct the simultaneous calling/ringing in conjunction with its location identifying infrastructure; a database with the numbers and instant message identities the cellular provider's customers would like to be reached at when there and the cells associated with those numbers and instant message identities; and the cellular provider's voice mail system.

When a Mobiline subscriber will be called, the cellular provider will propagate the call to the subscriber's cell phone as well as to a number (of the list designated by them) which is associated with the cell the subscriber currently resides within. If the cell where the user currently resides within is not any of the cells associated with the numbers and instant message identities the user would like to be reached at when there, the call will be propagated only to its cell phone.

The user may answer the call at any of the ringing devices. If the user does not answer a call at any of his ringing devices, the call will be picked-up by the user's cellular voice mail or by any other voice mail designated by the user.

In another embodiment, the Mobiline provider will use SIP (Session Initiated Protocol) via VOIP infrastructure to conduct the simultaneous calling/ringing in conjunction with a cellular provider's location identifying infrastructure; a database with the numbers and instant message identities the Mobiline provider's customers would like to be reached at when there and the cells associated with those numbers and instant message identities; and VOIP based voice mail system.

In this embodiment the Mobiline provider will partner with a cellular provider, as well as build a VOIP infrastructure, which will be connected to the POTS system or partner with an owner of such infrastructure. When a Mobiline subscriber will be called, the Mobiline provider will propagate the call to the subscriber's cell phone as well as to a number (of the list designated by them) which is associated with the cell the subscriber currently resides within (the cellular provider the Mobiline provider partnered with, will provide the cell ID where the user currently resides within). If the cell where the user currently resides within is not any of the cells associated with the numbers and instant message identities the user would like to be reached at when there, the call will be propagated only to its cell phone. The user may answer the call at any of the ringing devices. If the user does not answer a call at any of his ringing devices, the call will be picked-up by the VOIP based voice mail or by any other voice mail designated by the user.

The instant invention preferred embodiment solution is unique since by enabling to establish the parallel paths to the recipient while at the same time allowing him to know the call is for him. It enables the user to know when he is at home whether the call is to him or his wife based on who's cell phone is also ringing in addition to the home phone. In the instant invention preferred embodiment solution, the user's cell phone rings simultaneously with his home phone. Optionally, the home phone, when called by the recipient's cell phone service provider, rings with a different ring tone to alert other people using the home phone not to answer the call on the ringing device unless their cell phone is simultaneously ringing. While both above described embodiments easily enable the above, these are only two possible implementations.

The invention provide the routing of incoming calls to the subscriber to his cell phone and simultaneously to the landline phone which is geographically closest to his cell phone location. In other words, if the user defined two alternatives to his cell phone—one is his home phone and the other his work phone, the system will automatically call the user's home in addition to his cell phone if the cell phone geographic location is near the house (near and not exactly since initially the cell phone location will be limited to a cell resolution.

In the context of the following non-limiting illustrative example, AT&T will be used as a typical Infrastructure service provider. Nevertheless, it should be appreciated that any private, regional, national, or international telephone service provider could serve as a good example too.

What is AT&T Mobiline? Calls to the subscriber generate simultaneous rings on his AT&T cell phone and a landline that is geographically next to the cell phone geo location. The landline will be one of several possible numbers the subscriber gave where he may be found. The landline could be a VOIP line, a VOIP based Instant Messenger or any ILEC provided line. The subscriber may answer the call on any of the ringing devices while obviously answering the call not on his cell phone saves the subscriber precious airtime minutes that can be used for outgoing calls as well as provide him with the quality and convenience of a land line. If a call is not answered at any of the phones designated by the subscriber, the user's designated voicemail will pick-up the call.

Regarding the Value to AT&T Mobiline Subscriber, the AT&T Mobiline plans, even if they include the exact same buckets as competing plans and offered at the same price has a huge competitive advantage. The AT&T Mobiline subscriber will answer a significant portion of his incoming calls on other lines, saving him precious airtime minutes that can be used for outgoing calls as well as providing him with the quality and convenience of a land line on one hand while maintaining the personal qualities of the cell phone on the other hand.

Regarding US Cell Phone Market—Potential & Opportunity:

There are about 146 million US cell phone subscribers

About a third of the subscribers change carriers each year

Consumer advocates say the inability so far to retain (cell phone) numbers is one of the biggest barriers that prevented more cell phone users from switching in search of better service and prices

The Federal Communications Commission is now requiring wireless carriers to provide “number portability”

Wireless carriers CPGA is increasing due to continued slowdown in the industry growth rate

Verizon Wireless (largest wireless provider) ARPU: $47

AT&T Wireless (second largest wireless provider) ARPU: $58.70

AT&T Wireless CCPU: $30.60

(CPGA—Cost Per Gross subscriber Addition; Source: AT&T Wireless; ARPU—Average Revenue Per User (monthly); CCPU—Cash Cost Per User—used to measure the monthly average cost of serving a subscriber)

Regarding Mobiline—Potential Revenues

Mobiline monthly fee (ARPU)—at least $40

Every 10 million Mobiline subscribers will provide the Mobiline provider with incremental annual revenues of at least $4.8 B

Conclusion from the non limiting AT&T Mobiline example:

AT&T Mobiline service offers subscribers significant value enhancement by enabling them to receive incoming calls on other lines, therefore saving them precious airtime that can be used for outgoing calls as well as provide them with the quality and convenience of a land line while maintaining the qualities of the cell phone by letting subscribers know the call is for them (due to the simultaneously ringing cell phone) as well as the cellular voice mail that still picks up non-answered calls.

Notwithstanding the aforesaid, the instant invention relates to embodiments of a protocol for location-based telecommunications redundancy, operable at a data-communications topology juncture having at least two telecommunications media there-at, the protocol being substantially as herein before described and illustrated, and the protocol is characterized by an occurrence of a call-processing request—from a caller to a recipient—resulting in substantially simultaneously “ringing” of a plurality of proximate recipient respective-media devices, wherein one of the devices is a mobile telecommunications device.

Essentially the preferred mobiline application embodiment relates to a situation whereby a person is not picking another person's call on a landline, since he will recognize that the landline rings with a different tone therefore he won't pick-up unless his cell phone is also ringing.

Now, suppose that a few people share the same landline, then the preferably each of them will have a different ringing tone when the call originate at their respective cell phone. This way they don't need their cell phone next to them to know that the call is for them or for someone else with a cell phone that can also receive calls on this landline.

Operationally—when someone register a landline as a destination to be called when he is next to it, the cell phone company will recognize that another person has already register the landline as a destination for his cell phone and will therefore: 1) Inform the user currently registering the landline as a destination for his cell phone that another person has designated this landline as a destination line for his cell phone; and 2) that the cell phone company is assigning the user a different ringing tone than to the other user and then the cell phone company either calls the landline with the different ring so the user can recognize ‘his’ ring or simply play that ring to him.

Alternative variant mobiline solution embodiments according to the present invention relate to scenarios whereby:

Scenario-1) The phone companies enable people to add another telephone number to their telephone line and that the new number will ring differently (distinctive ring) on the line when that number is called.

Note: the Mobiline system enabled a distinctive ring on the landline is preferably used by the user with minimal to no changes on the landline provider's systems. While there are different ways to add a distinctive ring such as calling from a certain number recognized by the landline provider's system, preferably the caller ID feature on the landline is used to show the real caller and not the ID of the cellular provider offering Mobiline. The solution, add another telephone number to the landline used by the user WITHOUT telling the user we have done so. (iI.e. in order for the user to receive a call originating on his cell phone—ring on his landline with a distinctive ring—we added another telephone number to the user's landline so the user will receive the calls he wanted to receive to a certain phone number on a different number BUT on the same telephone line. The user is therefore unaware of the added telephone line.)

Scenario-2) In order to make the integration with the cellular provider's system as smooth and simple as possible, the Mobiline system is constantly monitoring the Geo location of the user. Whenever he is next to a landline he would like to be reached at, a ‘group calling’ is defined by Mobiline. Whenever the user leaves the landline, the ‘group calling’ feature is canceled by the Mobiline system. The user can probably cancel a group calling from his own cell phone easily therefore overriding the Mobiline system for a one time canceling of the service (to permanently cancel the user will have to call the 1800 registration number again).

Objectives: When designing the instant mobiline system the embodiment a goals have been to achieve the following:
1. Besides the registration, the user doesn't need to do anything in general and specifically doesn't need to buy any hardware.
2. Both the landline provider as well as the cell phone provider will be required to institute minimal resources in order to implement Mobiline. With this specific objective in mind, the Mobiline system was designed to use current available functionality.

Solution Description: Mobiline embodiments enable a subscriber to have calls that are made to their cell phone ring simultaneously on their cell phone as well as the landline where they are, simply by them entering that space. There is no need to buy any hardware or take any action. The consumer can then choose to answer the call on either phone.

When a consumer chooses to answer on a landline they get:
Better call quality
Cost savings—no air time charges
Cell phone battery power savings
Healthier call

Mobiline's technology also guarantees subscribers that calls to their landline will be answered by them since the landline will automatically ring with their distinctive tone that will tell everyone whose cell phone was called.

This new pattern of calls originating on a cell phone but taking place on a landline will change calling habits:

Callers will have a predisposition to call a cellular number before trying a landline number because they are more likely to reach the receiving party on one call and believe that the receiver has the choice of answering their call on the line most convenient to them.

In fact it opens the era of personal phone numbers.

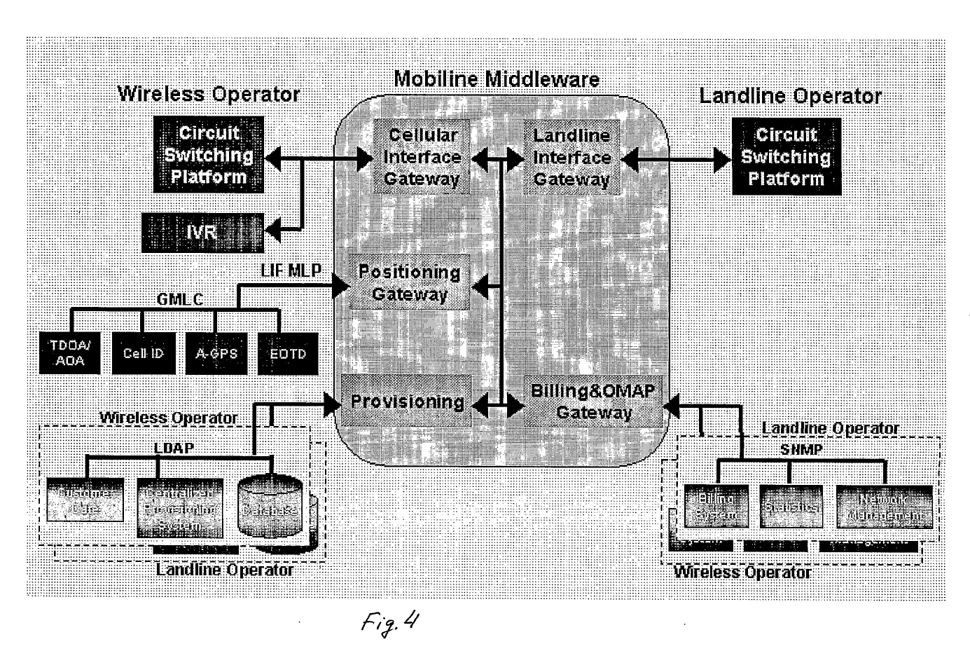

System Diagram: Workflow (turn now to FIG. 4)

Registration Process: The user is instructed to call a 1-800 registration number from his cell phone when he is standing next to a landline he would like to be reached at when there.

The cell phone will be used by the Mobiline system as a means to capture the coordinates of the landline.

While the landline coordinates may be acquired in different ways, using the cell phone itself is the best way to guarantee that inherent errors within the location technologies used by the wireless operators will not pinpoint the user to be at home when he is not there and the other way around for example.

The user's registration call is picked up by an IVR system that takes the user through the following procedure:
1. ‘Using your dial pad, please enter the number of the landline you would like to be reached at when you are at that location’
2. After receiving the landline number, the system will ask the user ‘Please stand next to the landline where you would like to be reached at and then press the star key twice on your cell phone dial pad.
3. When the star key is pressed twice the location of the landline is retrieved from the location based system used by the wireless operator.
4. The user is informed by the system that ‘the location of the landline you would like to be reached at when nearby has been recorded by the system. The Mobiline service will shortly be available to you on this landline’.
5. The system plays to the user the distinctive ring he will be hearing when calls to his cell phone ring on the landline. This way, the user will recognize calls for him according to the ring when he hears it.

Landline Set-Up Process

The landline provider's system is being contacted and the following takes place:
1. The landline provider's system is given the landline number the user would like to be reached at.
2. The landline provider's system assigns to the telephone line associated with the landline number the user would like to be reached at, an additional telephone number.
3. The landline provider allocates to the additional telephone number a distinctive ring, which is different than the rings assigned to the numbers already associated with this telephone line.
4. The landline provider sends to the Mobiline system the additional number assigned to the user's destination phone line.

It should be emphasized that the entire process is transparent to the user who is not aware that another number was assigned to his destination phone line.

Cellular Line Set-Up Process

The Mobiline system initiates a triggered location reporting service—whenever the user is recognized within 10 meters of the landline location (as recorded by his cell phone)—a triggered event will call the Mobiline system.

Call Routing Process

When the Mobiline system is informed via a triggered event that the user is next to a destination landline then the system goes ahead and defines a ‘group calling’ feature for the user. The group includes both the user's cell phone number as well as the additional telephone number assigned by the landline provider to the user's phone line.

Once recognized by the Mobiline system as being next to his destination landline, every call to the user's cell phone is simultaneously routed to both his cell phone as well as to his landline where it will ring with a distinctive ring.

As soon as the Mobiline system is informed of the user being next to a landline he would like to be reached at when he is at that location, the Mobiline system defines a triggered location reporting service that will inform it when the user will be recognized as no longer next to his landline.

When the Mobiline system is informed via a triggered event that the user is no longer next to his destination landline, the Mobiline system cancels the ‘group calling’ feature for the user. The next call to the user's cell phone will ring solely on his cell phone.

It should be emphasized that the user may define as many locations as he would like as landline destinations he would like to be reached at when he is at those locations.

In addition, notwithstanding the abovementioned embodiments of the instant invention, for many POTs telephone service providers there is a shortage of phone numbers, and therefore the suggested embodiment where the wireline (POTs) operator will assign another phone number to the landline designated by the user—for the purpose of calling the user with a distinctive ring for calls originating at his cell phone may be a problem. In such a case, the wireless operator may add at the beginning or the end of a call it is forwarding (to the user's wireline) a code that will be recognized by the wireline switch—that in return will call the user's landline with a predetermined distinctive ring.

In order to handle the situation where one landline is assigned by a few wireless subscribers as a destination line (such as at home where both the husband and wife are interested in receiving a call to their wireless phones on their home landline when they are at home) and each of the subscribers are interested in having a respectively distinctive ring—the wireless operator will use one code to indicate to the wireline operator to use one kind of a distinctive ring, a second code to indicate to the wireline operator to use a second kind of distinctive ring etc.

It should be emphasized that these suggested implementations of how to integrate the wireless and wireline operators are suggestions only and a different implementation may be chosen by the operators based on many variables including the capabilities of their installed systems, availability of phone numbers, availability of resources to implement the solutions, desired time to market etc.

According to another aspect of the instant invention, there is a preferred embodiment implementation that eliminates any substantial work by the wireline operator and requires the subscriber only to a one time placement of a very small (e.g. few inches) and very cheap device in serial to his landline. The subscriber simply disconnects the phone cord that enters his landline phone (e.g. at the phone or at the wall jack), connects the cord into the device and plugs the small cord provided with the device into the landline phone—effectively placing the device in serial to the phone. The device will recognize calls that originate from a certain specific number as calls to the subscriber's cell phone that were also routed by the wireless operator to the subscriber landline phone (when the subscriber is there). Whenever the device recognizes calls that originate from this specific phone number—it generates a distinctive ring on the landline phone.

In a situation where one landline is assigned by a few wireless subscribers as a destination line (such as at home where both husband and wife are interested in receiving a call to their wireless phones on their home landline when they are there) and each of the subscribers are interested in having a distinctive ring—the wireless operator will (for example) use one phone number in originating a call to the first subscriber to assign the landline as a destination, a different phone number for the second subscriber that assigned the landline as a destination and so forth. The device will generate one kind of a distinctive ring for calls that originate from one phone number (pre-configured in the device), a second kind of distinctive ring for calls that originate from a second phone number (pre-configured in the device), a third kind of distinctive ring for calls that originate from the third phone number (also pre-configured in the device) etc. As explained above, there is no need for more than one device per landline phone regardless of the number of subscribers that assigned the landline phone as their destination when there. It should be noted that while the wireless operator is using the exact same phone number to originate calls to subscribers' landlines (calls that were made to their cell phones) in order for the device to generate the distinctive ring—the wireless operator will also dynamically attach the caller ID of the real caller to the phone number it is using as the origin of the call so the device will recognize the number and generate the distinctive ring. The reason for the dynamically generated caller ID is for the landline phone to show the ID of the caller and not the ID of the wireless operator that routes the call.

The topology of the installation of the in-line-device may be schematically portrayed as (for example: Wall-jack—telephone-line—In-Line-Device—Telephone-unit) or as (for example: Wall-jack—In-Line-Device—telephone-line—Telephone-unit). The In-Line-Device per se may be schematically portrayed as having a wall-jack side and a telephone-unit side and there-between having a circuit capable of monitoring signals on the line; and the circuit upon recognizing a predetermined, programmable, or elective caller ID (or prefix or suffix thereto) will substitute (or concatenate, or otherwise insert) a predetermined, programmable, or elective ring-tone signal (distinctive) for the current ring-tone signal. Optionally, the circuit may have a manual input port (such as a push button) allowing the user to manually “program” the device to “recognize” a currently incoming caller ID or the circuit may have a more sophisticated input port (such as a USB or IR-signal detector, or the likes) to facilitate other variations that are evident to the man of the art. Simply stated, the circuit element is substantially a smart serial interconnection element between telephone unit and the wall jack—and the unit is firstly capable of being programmed to recognize a first signal component and to substitute or modify signal component causing a standard ring “envelope” into a distinctive ring causing signal; and is secondly capable of recognizing a first signal component (caller ID or the likes) and thereat modifying the signal stream to create a second signal component which results in a distinctive ring at the telephone unit. Of course, this circuit element may be integrated into the telephone unit by the manufacturer, and thus might not be located at the telephone unit socket.

Thus, while the invention has been described with respect to specific examples including presently preferred modes of carrying out the invention, those skilled in the art will appreciate that there are numerous variations and permutations of the above described protocols, systems and techniques that fall within the spirit and scope of the invention as set forth in the appended claims.

I/We claim:

1. A protocol for location-based telecommunications redundancy, operable at a data-communications topology juncture having at least two telecommunications media there-at, and the protocol includes the steps of:
a. On the occurrence of a call-processing request from a caller to a recipient, first software at-the-juncture accessing a substantially current location for the recipient; and
b. Using the current location, second software at-the-juncture propagating the request to “ring” at two call-receiving devices closest to the current location—wherein one of the devices is a mobile telecommunications device of the recipient and the other of the devices is a terrestrial device of the recipient that is closest to the current location of the recipient.

2. The protocol for location-based telecommunications redundancy according to claim 1 wherein the request to “ring” the terrestrial device is a request for a distinctive ringing.

3. The protocol for location-based telecommunications redundancy according to claim 1 wherein substantially current location for the recipient is derived from obtaining coordinates corresponding to a cell of the recipient's mobile telecommunications device.

4. The protocol for location-based telecommunications redundancy according to claim 3 wherein the coordinates are selected from the list:
a. A geographic map reference,
b. A telecommunication infrastructure logical location,
c. A mobile telecommunication service cell,
d. A mobile telecommunications micro-cell, and
e. A mobile telecommunications antenna coverage location.

5. The protocol for location-based telecommunications redundancy according to claim 1 wherein substantially current location for the recipient is derived from obtaining coordinates corresponding to an area of preference designated by the recipient.

6. An article of manufacture including a computer usable medium having computer readable program code embodied therein for facilitating a protocol for location-based telecommunications redundancy, operable at a data-communications topology juncture having at least two telecommunications media there-at, the computer readable program code in said article of manufacture including:
a. first computer readable program code for causing a computer to, on the occurrence of a call-processing request from a caller to a recipient, accessing a substantially current location for the recipient; and
b. tied to the first computer readable software, second computer readable program code for causing the computer, using the current location, propagating the request to “ring” at two call-receiving devices closest to the current location—wherein one of the devices is a mobile telecommunications device of the recipient and the other of the devices is a terrestrial device of the recipient that is closest to the current location of the recipient.

7. A program storage device readable by machine, tangibly embodying a program of instructions executable by the machine to perform steps for facilitating a protocol for location-based telecommunications redundancy, operable at a data-communications topology juncture having at least two telecommunications media there-at, said steps including:
a. Maintaining a substantially current location for a mobile device of a recipient;
b. Accepting from the recipient a list of at least one terrestrial devices, each device respectively identified by infrastructure predetermined logical alphanumeric assignment code;
c. Establishing a mobile telephone synonymous coordinate for each of the at least one terrestrial devices; and
d. Keeping a current preference correspondence between the current location of the mobile device of the recipient and a most proximate terrestrial device based on the respective synonymous coordinate.

8. A location registration method, for use in the protocol for location-based telecommunications redundancy, and the method includes the steps of (A) from a substantially mobile phone located next to a connected substantially terrestrial telecommunications unit, transmitting an accepted terrestrial-system identification number for the terrestrial unit; (B) at a predetermined juncture in a data-communications topology, recording the identification number in logical association with a base-station antenna-space location for the substantially mobile phone during the transmitting.

9. A protocol for location-based telecommunications redundancy, operable at a data-communications topology juncture having at least two telecommunications media there-at, the protocol substantially as herein before described and illustrated, and the protocol is characterized by an occurrence of a call-processing request—from a caller to a recipient—resulting in substantially simultaneously “ringing” of a plurality of proximate recipient respective-media devices wherein one of the devices is a mobile telecommunications device.
